(19) United States
(12) Patent Application Publication
(10) Pub. No.: US 2026/0266260 A1
(43) Pub. Date: Sep. 10, 2026

(54) OPERATION OF A WIND TURBINE

(71) Applicant: GE Vernova Renovables Espana, S.L., Barcelona (ES)

(72) Inventors: Isaac PINEDA AMO, Barcelona (ES); Ganesh NEOGI, Hamburg (DE)

(21) Appl. No.: 19/163,523

(22) PCT Filed: Mar. 10, 2023
(86) PCT No.: PCT/EP2023/056131

§ 371 Date: Sep. 9, 2025

(51) Int. Cl. F03D 7/02

(52) U.S. Cl. CPC F03D 7/0224; F05B 2240/95; F05B 2270/32; F05B 2270/332

(57) ABSTRACT

The present disclosure is related to methods for determining a thrust limit for a wind turbine and methods for operating a wind turbine. The methods comprise determining an operational state of a blade load monitoring system of the wind turbine. Additionally, the methods comprise adjusting a thrust threshold of the wind turbine at least partially based on the operational state of the blade monitoring system. Further, the methods also comprise operating the wind turbine such that a thrust load on a rotor of the wind turbine is maintained at or below the adjusted thrust threshold. A control system suitable to maintain thrust loads at or below a thrust threshold is also provided, as well as wind turbines including such a control system.

### FIELD

The present disclosure relates to wind turbines and methods and systems for operating wind turbines. The present disclosure more particularly relates to methods and systems for determining an operational state of a blade load measuring system and adjusting operation of the wind turbine based on the operational state of the blade. The present disclosure also relates to methods for determining an adjusted thrust threshold for use in operation of the wind turbine.

### BACKGROUND

Modern wind turbines are commonly used to supply electricity into the electrical grid. Wind turbines of this kind generally comprise a tower and a rotor arranged on the tower. The rotor, which typically comprises a hub and a plurality of blades, is set into rotation under the influence of the wind on the blades. Said rotation generates a torque that is normally transmitted through a rotor shaft to a generator, either directly (“directly driven” or “gearless”) or through the use of a gearbox. This way, the generator produces electricity which can be supplied to the electrical grid.

Offshore wind turbines have gained significant popularity in recent years due to a combination of factors. The offshore environment offers a consistent and strong wind resource, which is beneficial for generating electricity from wind power. The wind speeds are generally higher and more consistent offshore as compared to onshore, leading to higher energy output. Further, the offshore environment allows for the construction of larger turbines, as the lack of land-based constraints enables the turbines to be sited further apart from one another, and to be taller and have longer blades. This can result in a higher energy output per turbine, and thus a more efficient use of the wind resource.

However, offshore wind turbine sites are also associated with several challenges and issues due to the harsh and remote nature of the offshore environment. In some cases, access to the turbines can be difficult and time-consuming, as maintenance personnel must be transported to the turbines by boat or helicopter. This can be further complicated by weather circumstances, making it impossible to safely access the turbines for extended periods of time.

Further, the turbines' components and systems can be exposed to extreme weather conditions, which can lead to accelerated wear and tear, and may increase the likelihood of component failure. This can lead to increased downtime for the turbines and reduced energy output.

Also, installation and commissioning of offshore wind turbines may be more time consuming than for onshore wind turbines. Hoisting nacelle, rotor and rotor blades requires specific vessels and may not be possible in all wind conditions. Installation of a wind farm may therefore take a long time. Commissioning of the wind turbines also may take more time than for onshore wind turbines, since personnel may be required to go to the farm for testing and inspection. Commissioning may include tests of the wind turbine producing power, verification of protection systems, test of power measurements, plus many mechanical tests. Some of the tests may only be carried out in specific wind conditions which can delay the commissioning process.

Wind turbines may have a plurality of sensor systems which aid in or are vital to the safe and efficient operation of the wind turbine. For example, load sensors and accelerometers may be used throughout the wind turbine, in order to detect e.g. anomalous or dangerous situations.

Load sensors may be arranged on or with the blades for example in order to measure the loads on the blades. The input of such load sensors may be used directly as input in the operation of the wind turbine. For example, blade load measurements may be used in order to keep operational loads under control, particularly in view of the accumulation of fatigue loads, and also in view of maximum allowable loads. It is known to modify an operational thrust limit on a wind turbine in case of e.g. high turbulence. In practice, the operational parameters of the wind turbine may be changed, e.g. the blades may be pitched, rotor speed and output power may be reduced in order to keep the thrust on the wind turbine on the operational thrust limit.

As mentioned load sensors may be arranged with the blades, particularly near the root of the blades. Sensors may be arranged to measure both edgewise and flapwise loads. Sensors used for determining loads on the blades may also be arranged elsewhere, e.g. in the hub, or main rotor shaft, or with the pitch bearings or main bearings.

In some cases, commissioning and calibrating the blade load monitoring system of an offshore wind turbine can be a complex process due to the challenging conditions of the offshore environment, such as high winds and waves which can complicate access. In addition, a proper calibration of the blade load monitoring system may require specific wind conditions, e.g. relatively low wind speeds.

Delays in calibrating the blade monitoring system can lead to annual energy losses for the wind turbine. Since the system is not only used to optimize the turbine's performance but also to protect against critical loads, a wind turbine comprising an inoperative blade monitoring system is not allowed to operate. Similarly, the blade monitoring system may become less reliable after a certain period of operation due to wear and tear. When this is detected, the wind turbine's operation may be stopped.

The present disclosure provides methods and systems that at least partially overcome some of the aforementioned drawbacks associated with blade load monitoring systems.

### SUMMARY

In an aspect of the present disclosure, a method for determining a thrust threshold of a wind turbine is provided. The method comprises determining an operational state of a blade load monitoring system of the wind turbine and determining a thrust threshold of the wind turbine at least partially based on the operational state of the blade monitoring system and on wind turbulence.

According to this aspect, suitable operating parameters for the safe and efficient operation of a wind turbine can be provided, even if the blade load monitoring system is not working, has not been calibrated yet, or is not working properly. Rather than not operating the wind turbine at all, a suitable thrust threshold is provided based on whether or not the blade load monitoring system is operational or not.

In a further aspect of the present disclosure, a method for operating a wind turbine is provided. The method comprises determining an operational state of a blade load monitoring system of the wind turbine, and determining a thrust threshold for the wind turbine at least partially based on the operational state of the blade monitoring system. The method then further comprises operating the wind turbine such that a thrust load on a rotor of the wind turbine is at or below the determined thrust threshold.

In accordance with this aspect, the wind turbine can be operated in scenarios wherein the blade load monitoring system may not be available. This may be particularly relevant for offshore wind turbines, for which long delays in the commissioning of the blade monitoring system due to strong weather conditions may frequently occur. Thus, this method allows operating a wind turbine at an enhanced annual energy production output compared to other prior art approaches. The operation according to a maximum thrust level has moreover been found more efficient and can increase annual energy production as compared to an operation with a setpoint reduction (“downrating” of the wind turbine).

In yet a further aspect of the present disclosure, a wind turbine is provided which comprises a wind turbine tower, a rotor including one or more blades mounted on top of the tower, a blade load monitoring system for determining loads on the blades and a control system. The control system is configured to determine an operational state of the blade load monitoring system, to determine a thrust threshold for the wind turbine at least partially based on the operational state of the blade monitoring system, and to operate the wind turbine such that a thrust load on a rotor of the wind turbine is at or below the determined thrust threshold.

Throughout this disclosure, the term “turbulence intensity” may be understood as the standard deviation of wind speed over the mean value of wind speed. Turbulence intensity may be referred to as a percentage or as a decimal number below 1. Standard deviation of wind speed and mean value of wind speed may be determined over a fixed time interval. Such a time interval may be e.g. 10 minutes.

Throughout the present disclosure, a thrust load on the wind turbine may be regarded as the axial force applied by the wind on the rotor of a wind turbine. A thrust threshold may be regarded as a maximum level of thrust that is allowed in operation.

Additional objects, advantages and features of embodiments of the present disclosure will become apparent to those skilled in the art upon examination of the description, or may be learned by practice.

### BRIEF DESCRIPTION OF THE DRAWINGS

FIG. 1 schematically illustrates a perspective view of one example of a wind turbine;

FIG. 2 illustrates an example of a hub and a nacelle of a wind turbine;

FIG. 3 shows a flowchart of an example of a method for determining a thrust threshold;

FIG. 4 shows a flowchart of an example of a method for operating a wind turbine;

FIG. 5 shows a flowchart of a further example of a method for operating a wind turbine;

FIG. 6 shows a flowchart of yet another example of a method for operating of a wind turbine;

FIG. 7 shows a schematic diagram of a control system to control the operation of a wind turbine; and

FIG. 8 shows examples of power output curves of a wind turbine operating with an original thrust threshold, and adapted thresholds.

### DETAILED DESCRIPTION OF EXAMPLES

Reference now will be made in detail to embodiments of the disclosure, one or more examples of which are illustrated in the drawings. Each example is provided by way of explanation, not as a limitation. In fact, it will be apparent to those skilled in the art that various modifications and variations can be made in the present disclosure without departing from the scope or spirit of the teaching. For instance, features illustrated or described as part of one embodiment can be used with another embodiment to yield a still further embodiment. Thus, it is intended that the present disclosure covers such modifications and variations as come within the scope of the appended claims and their equivalents.

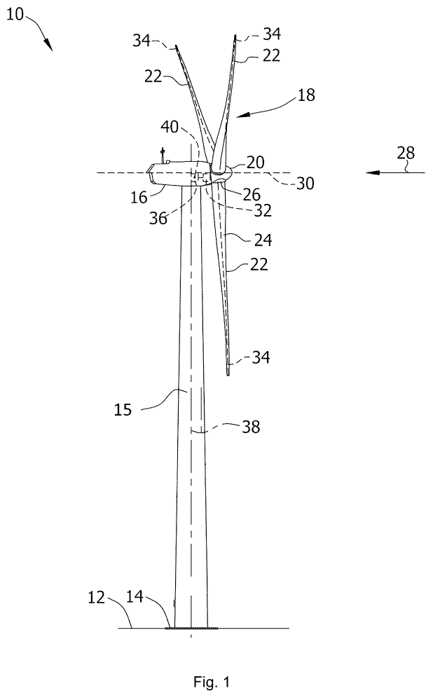

FIG. 1 is a perspective view of an example of a wind turbine 10. In the example, the wind turbine 10 is a horizontal-axis wind turbine. Alternatively, the wind turbine 10 may be a vertical-axis wind turbine. In the example, the wind turbine 10 includes a tower 15 that extends from a support system 14 on a ground 12, a nacelle 16 mounted on tower 15, and a rotor 18 that is coupled to nacelle 16. The rotor 18 includes a rotatable hub 20 and at least one rotor blade 22 coupled to and extending outward from the hub 20. In the example, the rotor 18 has three rotor blades 22. In an alternative embodiment, the rotor 18 includes more or less than three rotor blades 22. The tower 15 may be fabricated from tubular steel to define a cavity (not shown in FIG. 1) between a support system 14 and the nacelle 16. In an alternative embodiment, the tower 15 is any suitable type of a tower having any suitable height. According to an alternative, the tower can be a hybrid tower comprising a portion made of concrete and a tubular steel portion. Also, the tower can be a partial or full lattice tower.

The rotor blades 22 are spaced about the hub 20 to facilitate rotating the rotor 18 to enable kinetic energy to be transferred from the wind into usable mechanical energy, and subsequently, electrical energy. The rotor blades 22 are mated to the hub 20 by coupling a blade root portion 24 to the hub 20 at a plurality of load transfer regions 26. The load transfer regions 26 may have a hub load transfer region and a blade load transfer region (both not shown in FIG. 1). Loads induced to the rotor blades 22 are transferred to the hub 20 via the load transfer regions 26.

In examples, the rotor blades 22 may have a length ranging from about 15 meters (m) to about 90 m or more. Rotor blades 22 may have any suitable length that enables the wind turbine 10 to function as described herein. For example, non-limiting examples of blade lengths include 20 m or less, 37 m, 48.7 m, 50.2m, 52.2 m or a length that is greater than 91 m. As wind strikes the rotor blades 22 from a wind direction 28, the rotor 18 is rotated about a rotor axis 30. As the rotor blades 22 are rotated and subjected to centrifugal forces, the rotor blades 22 are also subjected to various forces and moments. As such, the rotor blades 22 may deflect and/or rotate from a neutral, or non-deflected, position to a deflected position.

Moreover, a pitch angle of the rotor blades 22, i.e., an angle that determines an orientation of the rotor blades 22 with respect to the wind direction, may be changed by a pitch system 32 to control the load and power generated by the wind turbine 10 by adjusting an angular position of at least one rotor blade 22 relative to wind vectors. Pitch axes 34 of rotor blades 22 are shown. During operation of the wind turbine 10, the pitch system 32 may particularly change a pitch angle of the rotor blades 22 such that the angle of attack of (portions of) the rotor blades are reduced, which facilitates reducing a rotational speed and/or facilitates a stall of the rotor 18.

In the example, a blade pitch of each rotor blade 22 is controlled individually by a wind turbine controller 36 or by a pitch control system 80. Alternatively, the blade pitch for all rotor blades 22 may be controlled simultaneously by said control systems.

Further, in the example, as the wind direction 28 changes, a yaw direction of the nacelle 16 may be rotated about a yaw axis 38 to position the rotor blades 22 with respect to wind direction 28.

In the example, the wind turbine controller 36 is shown as being centralized within the nacelle 16, however, the wind turbine controller 36 may be a distributed system throughout the wind turbine 10, on the support system 14, within a wind farm, and/or at a remote-control center. The wind turbine controller 36 includes a processor 40 configured to perform the methods and/or steps described herein. Further, many of the other components described herein include a processor.

As used herein, the term “processor” is not limited to integrated circuits referred to in the art as a computer, but broadly refers to a controller, a microcontroller, a microcomputer, a programmable logic controller (PLC), an application specific, integrated circuit, and other programmable circuits, and these terms are used interchangeably herein. It should be understood that a processor and/or a control system can also include memory, input channels, and/or output channels.

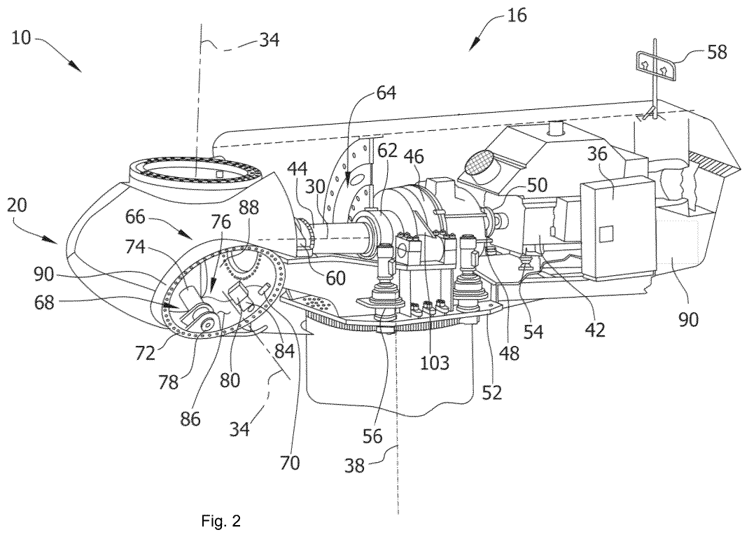

FIG. 2 is an enlarged sectional view of a portion of the wind turbine 10. In the example, the wind turbine 10 includes the nacelle 16 and the rotor 18 that is rotatably coupled to the nacelle 16. More specifically, the hub 20 of the rotor 18 is rotatably coupled to an electric generator 42 positioned within the nacelle 16 by the main shaft 44, a gearbox 46, a high-speed shaft 48, and a coupling 50. In the example, the main shaft 44 is disposed at least partially coaxial to a longitudinal axis (not shown) of the nacelle 16. A rotation of the main shaft 44 drives the gearbox 46 that subsequently drives the high-speed shaft 48 by translating the relatively slow rotational movement of the rotor 18 and of the main shaft 44 into a relatively fast rotational movement of the high-speed shaft 48. The latter is connected to the generator 42 for generating electrical energy with the help of a coupling 50. Furthermore, a transformer 90 and/or suitable electronics, switches, and/or inverters may be arranged in the nacelle 16 in order to transform electrical energy generated by the generator 42 having a voltage between 400V to 1000 V into electrical energy having medium voltage (10-35 KV). Said electrical energy is conducted via power cables from the nacelle 16 into the tower 15.

The gearbox 46, generator 42 and transformer 90 may be supported by a main support structure frame of the nacelle 16, optionally embodied as a main frame 52. The gearbox 46 may include a gearbox housing that is connected to the main frame 52 by one or more torque arms 103. In the example, the nacelle 16 also includes a main forward support bearing 60 and a main aft support bearing 62. Furthermore, the generator 42 can be mounted to the main frame 52 by decoupling support means 54, in particular in order to prevent vibrations of the generator 42 to be introduced into the main frame 52 and thereby causing a noise emission source.

Optionally, the main frame 52 is configured to carry the entire load caused by the weight of the rotor 18 and components of the nacelle 16 and by the wind and rotational loads, and furthermore, to introduce these loads into the tower 15 of the wind turbine 10. The rotor shaft 44, generator 42, gearbox 46, high speed shaft 48, coupling 50, and any associated fastening, support, and/or securing device including, but not limited to, support 52, and forward support bearing 60 and aft support bearing 62, are sometimes referred to as a drive train 64.

In some examples, the wind turbine may be a direct drive wind turbine without gearbox 46. Generator 42 operate at the same rotational speed as the rotor 18 in direct drive wind turbines. They therefore generally have a much larger diameter than generators used in wind turbines having a gearbox 46 for providing a similar amount of power than a wind turbine with a gearbox.

The nacelle 16 may also include a yaw drive mechanism 56 that may be used to rotate the nacelle 16 and thereby also the rotor 18 about the yaw axis 38 to control the perspective of the rotor blades 22 with respect to the wind direction 28.

For positioning the nacelle 16 appropriately with respect to the wind direction 28, the nacelle 16 may also include at least one meteorological measurement system 58 which may include a wind vane and anemometer. The meteorological measurement system 58 can provide information to the wind turbine controller 36 that may include wind direction 28 and/or wind speed. In the example, the pitch system 32 is at least partially arranged as a pitch assembly 66 in the hub 20. The pitch assembly 66 includes one or more pitch drive systems 68 and at least one sensor 70. Each pitch drive system 68 is coupled to a respective rotor blade 22 (shown in FIG. 1) for modulating the pitch angle of a rotor blade 22 along the pitch axis 34. Only one of three pitch drive systems 68 is shown in FIG. 2.

In the example, the pitch assembly 66 includes at least one pitch bearing 72 coupled to hub 20 and to a respective rotor blade 22 (shown in FIG. 1) for rotating the respective rotor blade 22 about the pitch axis 34. The pitch drive system 68 includes a pitch drive motor 74, a pitch drive gearbox 76, and a pitch drive pinion 78. The pitch drive motor 74 is coupled to the pitch drive gearbox 76 such that the pitch drive motor 74 imparts mechanical force to the pitch drive gearbox 76. The pitch drive gearbox 76 is coupled to the pitch drive pinion 78 such that the pitch drive pinion 78 is rotated by the pitch drive gearbox 76. The pitch bearing 72 is coupled to pitch drive pinion 78 such that the rotation of the pitch drive pinion 78 causes a rotation of the pitch bearing 72.

Pitch drive system 68 is coupled to the wind turbine controller 36 for adjusting the pitch angle of a rotor blade 22 upon receipt of one or more signals from the wind turbine controller 36. In the example, the pitch drive motor 74 is any suitable motor driven by electrical power and/or a hydraulic system that enables pitch assembly 66 to function as described herein. Alternatively, the pitch assembly 66 may include any suitable structure, configuration, arrangement, and/or components such as, but not limited to, hydraulic cylinders, springs, and/or servomechanisms. In certain embodiments, the pitch drive motor 74 is driven by energy extracted from a rotational inertia of hub 20 and/or a stored energy source (not shown) that supplies energy to components of the wind turbine 10.

The pitch assembly 66 may also include one or more pitch control systems 80 for controlling the pitch drive system 68 according to control signals from the wind turbine controller 36, in case of specific prioritized situations and/or during rotor 18 overspeed. In the example, the pitch assembly 66 includes at least one pitch control system 80 communicatively coupled to a respective pitch drive system 68 for controlling pitch drive system 68 independently from the wind turbine controller 36. In the example, the pitch control system 80 is coupled to the pitch drive system 68 and to a sensor 70. During normal operation of the wind turbine 10, the wind turbine controller 36 may control the pitch drive system 68 to adjust a pitch angle of rotor blades 22.

According to an embodiment, a power generator 84, for example comprising a battery and electric capacitors, is arranged at or within the hub 20 and is coupled to the sensor 70, the pitch control system 80, and to the pitch drive system 68 to provide a source of power to these components. In the example, the power generator 84 provides a continuing source of power to the pitch assembly 66 during operation of the wind turbine 10. In an alternative embodiment, power generator 84 provides power to the pitch assembly 66 only during an electrical power loss event of the wind turbine 10. The electrical power loss event may include power grid loss or dip, malfunctioning of an electrical system of the wind turbine 10, and/or failure of the wind turbine controller 36. During the electrical power loss event, the power generator 84 operates to provide electrical power to the pitch assembly 66 such that pitch assembly 66 can operate during the electrical power loss event.

In the example, the pitch drive system 68, the sensor 70, the pitch control system 80, cables, and the power generator 84 are each positioned in a cavity 86 defined by an inner surface 88 of hub 20. In an alternative embodiment, said components are positioned with respect to an outer roof surface of hub 20 and may be coupled, directly or indirectly, to the outer roof surface.

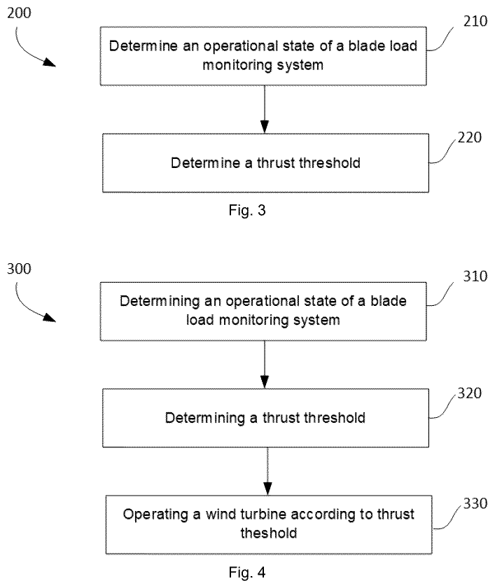

FIG. 3 shows a flowchart of an example of a method 200 for determining a thrust threshold of a wind turbine. The method comprises, at block 210, determining an operational state of a blade load monitoring system of the wind turbine. The method further comprises, at block 220, determining a thrust threshold of the wind turbine at least partially based on the operational state of the blade monitoring system and on wind turbulence.

An operational state of the blade load monitoring system may either be “correct” or “operational”, or may be “incorrect” or “non-operational”. The status “correct” may refer to a status in which the sensors have been calibrated and commissioned and are deemed to work correctly. If the sensors have not been calibrated yet (i.e. prior to commissioning), or a deviation from normal functioning is noted during operation, the status may change to “incorrect” or “non-operational”: even if measurements are obtained, these are not reliable and monitoring of critical loads cannot be dependent on such sensors when they are not sufficiently reliable.

In some examples, the method 200 for determining a thrust threshold may comprise determining a turbulence intensity at or near the wind turbine, and determining the thrust threshold at least partially based on the determined turbulence intensity.

In some examples, the method may further comprise determining a wind speed at or near the wind turbine, and determining the thrust threshold at least partially based on the determined wind speed. Known wind speed measurement systems involving e.g. anemometers, hot wire anemometry, pitot tube, mechanical anemometry, SODAR, LIDAR or other suitable systems may be used to determine wind speed variation over specific intervals. Additionally, mean wind speed and wind speed variation may be estimated based on a signal of any suitable sample length, e.g. 2 minutes, 5 minutes, 10 minutes or any other longer or shorter length in time. Further, the acquisition rate of the signal may also be adapted to wind characteristics, e.g. mean value of wind speed. Acquisition rates may vary from 10 Hz to 10 KHz, also depending on e.g. the measurement technique used and the computational power of the system in charge of computing wind parameters. The mean wind speed may be determined, as well as a standard deviation of the wind speed with respect to the mean. This is an indication of the intensity of turbulence. In examples, the adjusted thrust threshold may be partially based on wind turbulence. For example, the adjusted thrust threshold may be at least partially based on wind turbulence intensity.

In normal operation of a wind turbine, thrust loads may be particularly high close to a nominal wind speed of a wind turbine. Higher turbulence will however lead to higher thrust loads. The combination of both wind speed and turbulence intensity may be taken into account to determine thrust thresholds.

In some examples, the method may comprise determining a plurality of first thrust thresholds for an operational blade load monitoring system and a plurality of second thrust thresholds for a non-operational blade load monitoring system. The method may then comprise selecting a thrust threshold from the plurality of first and second thrust thresholds.

A plurality of predefined thrust thresholds may be provided for combinations of ranges or “bins” of wind speed, and for ranges or “bins” of turbulence intensity. Determining a suitable thrust threshold may then comprise selecting one of the predefined thresholds.

Purely by way of example, for a wind speed range of 10-12 m/s, and a turbulence intensity of 20-22%, a thrust threshold level of X may be defined for a wind turbine with an operational, well functioning, blade load monitoring system. For the same wind speed range and turbulence intensity, a thrust threshold of X-3% may be defined.

Similarly, by way of example, for a wind speed range of 16-18 m/s and a turbulence intensity of 18-20%, a thrust threshold of Y may be defined for a wind turbine with an operational, well functioning, blade load monitoring system. For the same combination of wind speed and turbulence intensity with a dysfunctional blade load monitoring system, a thrust threshold of Y-5% may be defined. And for the same wind speed, but a turbulence intensity of 24-28%, a thrust threshold of Y-10% may be defined in an example.

FIG. 4 schematically illustrates a method 300 for operating a wind turbine 10 according to an example of the present disclosure. The method 300 in FIG. 3 comprises, at block 310, determining an operational state of a blade load monitoring system of the wind turbine 10. The method 300 also comprises, at block 320, determining a thrust threshold of the wind turbine 10 at least partially based on the operational state of the blade monitoring system. Further, the method 300, at block 330, comprises operating the wind turbine 10 such that a thrust load on a rotor 18 of the wind turbine 10 is maintained at or below the adjusted thrust threshold.

As previously discussed, method 300 can determine the operational state of the blade load monitoring system, e.g. it may determine that the blade load monitoring system has poor communication with a wind turbine control system, it may also determine that sensors of the blade load monitoring system are not calibrated, are not in operation or it may provide sensor fault detection, among others. Thus, method 300 can adjust a thrust threshold of the wind turbine 10 to provide structural protection to the wind turbine components accordingly. Further, method 300 allows operating a wind turbine even before the blade monitoring system has been commissioned, e.g. due to inaccessibility for severe weather conditions. This may result in a considerable increase in the annual energy production of a wind turbine, without compromising the safe operation of the wind turbine.

In examples, the method may comprise establishing a lower thrust threshold when the blade monitoring system is inactive or unreliable.

In examples, operating the wind turbine, at block 330, such that the thrust load on the rotor of the wind turbine is at or below the determined thrust threshold comprises modifying a pitch angle of a wind turbine blade. In further examples, also generator torque or other actuators may be used to e.g. reduce a speed of rotation of a wind turbine and/or lower an aerodynamic torque on the wind turbine rotor.

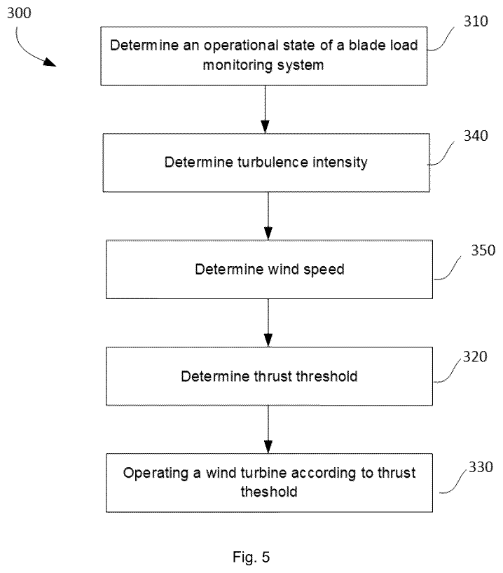

FIG. 5 illustrates another example of a method of operating a wind turbine according to an example of the present disclosure. The method of operating a wind turbine 300 may comprise the same steps as illustrated in FIG. 4, i.e. determining an operational status of a blade load monitoring system at block 310, and determining a thrust threshold at least partially based on this operational status at block 320.

The method 300 may further comprise determining a turbulence intensity at or near the wind turbine at block 340, and determining the thrust threshold at least partially based on the determined turbulence intensity.

The method 300 may further comprise determining a wind speed, at block 350, at or near the wind turbine, and determining the thrust threshold at least partially based on the determined wind speed.

Although the steps 340, 350, 320 have been indicated in a specific order, it should be clear that this order may be changed. Also, the method illustrated in FIG. 4 (as well as the methods illustrated in other figures) may be carried out continuously and/or may be repeated with a predetermined frequency.

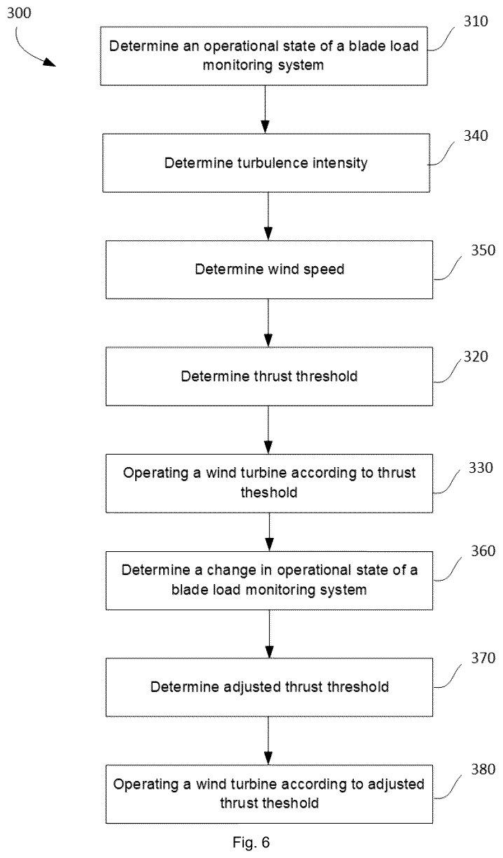

FIG. 6 illustrates yet a further example of a method for operating a wind turbine. In yet further examples, the method 300 for operating a wind turbine may comprise determining a changed operational state of a blade load monitoring system of the wind turbine at block 360, and, at block 370, determining an adjusted thrust threshold for the wind turbine at least partially based on the changed operational state of the blade monitoring system. The method may then further comprise, at block 380, operating the wind turbine such that a thrust load on the rotor of the wind turbine is at or below the adjusted thrust threshold.

In examples, adjusting the thrust threshold of the wind turbine comprises reducing the thrust threshold when the blade monitoring system is inactive or has become unreliable. As previously discussed, this may be due to, e.g., a faulty sensor or a blade monitoring system. The thrust threshold may be reduced for any other technical reason associated with the blade monitoring system.

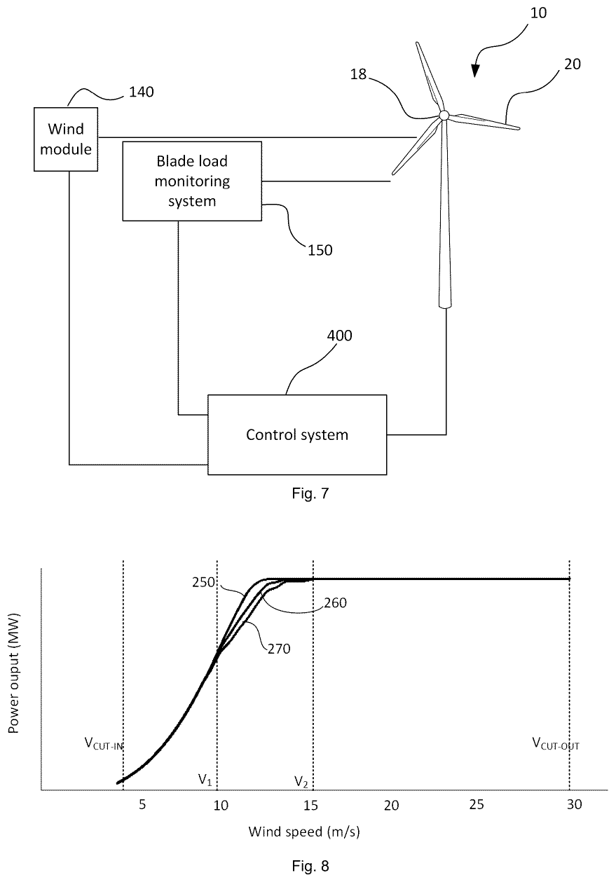

FIG. 7 shows a schematic diagram of wind turbine 10, comprising comprising a rotor 18 including one or more blades 20, a blade load monitoring system 150 and a control system 400.

The control system 400 is configured to determine an operational state of the blade load monitoring system 150, to determine a thrust threshold for the wind turbine 10 at least partially based on the operational state of the blade monitoring system 150, and to operate the wind turbine 10 such that a thrust load on a rotor of the wind turbine is at or below the determined thrust threshold.

In examples, the wind turbine 10 may comprise one or more pitch systems for rotating the blades along their longitudinal axes, and the control system is configured to control the pitch systems to maintain thrust loads at or below the determined thrust threshold.

Further, the thrust threshold adjusted by the control system 400 may be partially based on wind turbulence, and more specifically on wind turbulence intensity. In examples, the wind turbine may comprise one or more systems for measuring a wind speed, and wherein the control system is further configured to determine a turbulence intensity based on the measured wind speed.

In some examples, wind parameters such as wind turbulence intensity may be estimated by a wind module 140 located in the wind turbine 10, and this may be in data communication with the control system 400. Data may be communicated by cable or wirelessly.

In other examples, the wind module 140 may be located at a distant location from the wind turbine 10, e.g. a wind module 140 may provide wind parameters to a plurality of control systems 400 of respective wind turbines 10.

In examples, the control system 400 may be further configured to reduce the thrust threshold when one or more blade load monitoring systems 150 are not operative. For example, the control system 400 may reduce the thrust threshold of the wind turbine 10 when a single blade load monitoring system 150 is not calibrated or when one or more blade load monitoring systems 150 have not yet been commissioned. Other technical reasons causing the blade load monitoring system(s) 150 to be inoperative or faulty may also cause the control system 400 to reduce the thrust threshold of the wind turbine 10.

FIG. 8 shows examples of power (output) curves of a wind turbine operating with an original thrust threshold, and adapted thresholds. A power curve of a wind turbine describes the output power of a wind turbine as a function of hub height wind speed.

FIG. 8 shows three power curves. A power curve 250 may correspond to a power curve for normal operation, i.e. a normal functioning blade load monitoring system. Two further power curves 260, 270 are shown for operation of a wind turbine with a non-functional blade load monitoring system for different turbulence levels, power curve 260 for a first turbulence intensity level, and power curve 270 for a higher turbulence intensity.

It is known that aerodynamic thrust on the wind turbine rotor is high in the wind speed range around the power knee (a range of wind speeds close to the nominal wind speed, at which rotor rotational speed may be nominal or close to nominal).

A method of operating a wind turbine may comprise determining a plurality of first thrust thresholds for an operational blade load monitoring system and for predetermined combinations of wind speed range and turbulence intensity range and a plurality of second thrust thresholds for a non-operational blade load monitoring system for the predetermined combinations of wind speed range and turbulence intensity range.

Such a method may further comprise determining a turbulence intensity at or near the wind turbine and determining a wind speed at or near the wind turbine and selecting a thrust threshold from the first and second thrust thresholds based on the determined turbulence intensity, the determined wind speed and the operational state of the blade load monitoring system.

I.e. a number of thrust thresholds may be predefined, and depending on the wind conditions and the operational status of the blade load monitoring system, a suitable thrust threshold may be selected from the plurality of predefined thresholds.

In some examples, the first and second thrust thresholds may be the same for a wind speed range from cut-in wind speed to a first wind speed. A cut-in wind speed V_{CUT-IN} is the wind speed at which the wind turbine is able to generate power. As may be seen in the example of FIG. 8, until the first wind speed V₁ the risk of high blade loads is relatively low, so that even with a malfunctioning blade load monitoring system no specific measure is necessary.

In examples, the second thrust thresholds may be between 3 and 12% lower for each wind turbine intensity range for a wind speed range from the first wind speed V₁ to a second wind speed V₂.

The first wind speed V₁ may be below a nominal wind speed for the wind turbine, e.g., around 10 m/s and the second wind speed V₂ may be above a nominal wind speed for the wind turbine, e.g., around 15 m/s. At higher wind speeds, the wind turbine blades may be pitched to such an extent to maintain constant rotational speed, and constant (nominal) power output, that thrust is reduced to levels that normal operation may be possible even with a malfunctioning blade load monitoring system.

This written description uses examples to disclose the teaching, including the preferred embodiments, and also to enable any person skilled in the art to practice the teaching, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1-15. (canceled)

16. A method for determining a thrust threshold of a wind turbine, the method comprising:
determining an operational state of a blade load monitoring system of the wind turbine;
determining a wind turbulence at or near the wind turbine; and
determining the thrust threshold of the wind turbine at least partially based on the operational state of the blade monitoring system and on the wind turbulence.

17. The method according to claim 16, wherein determining the wind turbulence at or near the wind turbine comprises determining a level of the wind turbulence at or near the wind turbine, and determining the thrust threshold at least partially based on the determined level of wind turbulence.

18. The method according to claim 17, wherein the level of the wind turbulence is determined as a turbulence intensity.

19. The method according to claim 16, further comprising determining a wind speed at or near the wind turbine, and determining the thrust threshold at least partially based on the determined wind speed.

20. The method according to claim 19, further comprising:
determining a plurality of first thrust thresholds for an operational state of the blade load monitoring system;
determining a plurality of second thrust thresholds for a non-operational state of the blade load monitoring system; and
selecting a thrust threshold from the plurality of first and second thrust thresholds based on the operational state of the blade load monitoring system.

21. The method according to claim 20, wherein the plurality of first thresholds are provided for predetermined combinations of wind speed range and turbulence intensity range, and the plurality of second thresholds are provided for the same predetermined combinations of wind speed range and turbulence intensity range, and the method further comprising:
determining a turbulence intensity at or near the wind turbine;
determining a wind speed at or near the wind turbine; and
selecting a thrust threshold from the first and second thrust thresholds based on the determined turbulence intensity, the determined wind speed, and the operational state of the blade load monitoring system.

22. The method according to claim 21, wherein the first and second thrust thresholds are the same for a wind speed range from cut-in wind speed to a first wind speed.

23. The method according to claim 22, wherein the second thrust thresholds are between 3% and 12% lower for each wind turbine intensity range for a wind speed range from the first wind speed to a second wind speed.

24. The method according to claim 23, wherein the first wind speed is below a nominal wind speed for the wind turbine, and wherein the second wind speed is above a nominal wind speed for the wind turbine.

25. A method for operating a wind turbine, the method comprising:
determining a thrust threshold for the wind turbine according to claim 16; and
operating the wind turbine such that a thrust load on a rotor of the wind turbine is at or below the determined thrust threshold.

26. The method according to claim 25, comprising modifying a pitch angle of one or more wind turbine blades to operate the wind turbine such that the thrust load on the rotor of the wind turbine is at or below the determined thrust threshold.

27. The method according to claim 25, wherein the wind turbine is operated prior to calibrating the blade load monitoring system.

28. The method according to claim 25, further comprising:
determining a changed operational state of the blade load monitoring system of the wind turbine,
determining an adjusted thrust threshold for the wind turbine at least partially based on the changed operational state of the blade monitoring system; and
operating the wind turbine such that the thrust load on the rotor of the wind turbine is at or below the adjusted thrust threshold.

29. A wind turbine, comprising:
a wind turbine tower;
a rotor including one or more blades mounted on top of the tower;
a blade load monitoring system configured to determine loads on the blades; and
a control system configured to operate the wind turbine such that a thrust load on the is at or below the determined thrust threshold, wherein the control system is further configured to determine the thrust threshold according to the method of claim 16.

30. The wind turbine according to claim 29, wherein the wind turbine is an offshore wind turbine.
